(19) United States
(12) Patent Application Publication
(10) Pub. No.: US 2006/0195536 A1
(43) Pub. Date: Aug. 31, 2006

(54) Communication management apparatus, communication management method, and communication management program

(76) Inventors: Sogo Tsuboi, Kanagawa-ken (JP); Takehiko Yokota, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/362,010

(22) Filed: Feb. 27, 2006

(30) Foreign Application Priority Data
Feb. 28, 2005 (JP) P2005-53705

(51) Int. Cl. G06F 15/16

(52) U.S. Cl. 709/206

(57) ABSTRACT

A communication management apparatus includes: a receiving module which receives a message that is posted from a first terminal and includes information about the first terminal; an acceptance module which accepts a browse request for the received message from a second terminal that is different from the first terminal; a recording module which records history of a posting and a reply between the first terminal and the second terminal; a changing module which processes information about at least the first terminal in the received message in accordance with the history of the posting and the reply; and a sending module which sends a result processed at the changing module to the second terminal.

### CROSS-REFERENCE TO RELATED APPLICATIONS

This application is based upon and claims the benefit of priority from prior Japanese Patent Application No. 2005-053705, filed Feb. 28, 2005, the entire contents of which are incorporated herein by reference.

### BACKGROUND OF THE INVENTION

1. Field of the Invention

The present invention relates to a communication management apparatus, a communication management method, and a communication management program using networks and, more particularly, to a communication management apparatus which enables communication while preserving the ability for users to post anonymously.

2. Description of the Related Art

Present methods for efficient exchange and sharing of information over networks include, for example, mailing lists, bulletin board systems, and NetNews. When communication management apparatus and management systems are classified by how user posting is accomplished, there are mainly two types. One type is a system that accepts messages posted anonymously, and the other is a system that requires names. The latter includes those utilizing contributor information such as a mail address and an account name, which are difficult to change. Here the term “anonymously” means anonymous with respect to participant users, and not necessarily with respect to the system. In particular, the system records the originator's mail address or other information, but does not make this information open to a participant user.

In systems which permit anonymous posting, many comments can be expected because there are fewer barriers to prospective contributors. Sometimes, information is provided and information is exchanged that would not be provided or exchanged in other environments.

Of course, a degraded quality of content and mischievous messages are highly likely to occur. In particular, it can be a serious problem if meaningless, irrelevant, and erroneous messages, collectively called “vandalism,” are repeated by individuals or groups of people. Moreover, sometimes one person masquerades as another person, taking credit for other postings, and/or distorts information from another person.

Furthermore, it sometimes occurs that a person exchanges information because the person finds the anonymity convenient. However, the anonymity might be an obstacle to the person for other reasons. For example, the following cannot be done: a person who offers valuable information wants the receiver to remember that they have exchanged valuable information, a person wants to remember a receiver with whom they have exchanged valuable information, or a person agrees with a receiver at the end of discussions to tell how to identify themselves to each other, which is likely to make it easier for a relationship to develop.

On the other hand, in systems requiring posters to use names, it is expected that proper discussions and comments are exchanged because people are responsible for what they write. However, there is a problem that people tend to be timid about making comments, and may find it difficult to raise an elementary question, for example. In addition, many people have difficulty making public comments to many other people without getting feedback. There might be cases where a person wants their identity hidden until discussions are over, or a person wants to secretly ask about a subject in progress.

In both the anonymous and named-based systems discussed, various improvements have been devised which attempt to compensate for the inadequacies discussed above.

The following are examples of systems emphasizing anonymous posting. Here, anonymous posting means that identification information is not written on a bulletin board system for the public to see, regardless of whether some method of identifying the person is used by the system such as recording a contributor's IP address on a management server.

In 2-channel, (http://www.2ch.net) a well known website for anonymous communication, a fixed length of alphanumeric characters for ID (identification) is computed from “originator information” (for example, the Internet Protocol address) of a contributor, and it sent with each posting. It is hidden in normal discussion sections (called a “board”0 in 2-channel jargon), but the ID is made public along with posted contents in discussion sections dealing with subjects that cause anger, allowing determination of whether several posters are actually the same person. This allows determination whether acts of vandalism are committed by the same person. However, since one can change the “originator information” and thus the ID simply by reconnecting to the network, complete prevention of such vandalism is not achieved. Moreover, in order to take measures against acts by dishonest contributors, schemes are also provided such as self-disclosure of the originator information called “fusianasan”, and a mechanism requiring a user to create and present an ID by a password in order to demonstrate the user's identity. They work effectively when dishonest use is known beforehand. They can be thoroughly evaluated because they are simple schemes in practice. However, such approaches tend to reduce the merits of anonymous posting.

Functions for ignoring particular people or keywords can be incorporated in a client viewer that manages posting to Netnews and mailing lists. Such a client viewer does not display or rejects messages clearly containing vandalism. A prediction as to the identity of the person is made based on originator information such as a mail address or an IP address. Since keywords and originator information have to be registered one by one, databases that contain notorious users and keywords are sometimes made public by volunteers

In JP-A-2003-157279 (page 5, FIG. 1), user's profile information known only by the system is used to provide tailored discussion sections. It is expected that the user's taste and opinions about subjects are matched with discussion in order to avoid vandalism.

In JP-A-2003-281142 (page 7, FIG. 1) and JP-A-2004-62865 (page 15, FIG. 5), a user can evaluate the other users, and bonuses and sanctions can be imposed based on the evaluations. These patent publications indicate that the scheme can prevent vandalism. Since a “user” according to these references can be uniquely identified in a virtual space, participation in the service is by name.

The methods described in these patent publications are analogous to the user rating that is a basic scheme in net auctions typified by Yahoo! Auction today (http://auction.yahoo.co.jp). As findings obtained from these services indicate, users with negative evaluations simply re-register in order to start over without the negative evaluations. To combat this problem, a method is used in which a person is induced to keep registered information by improving evaluation scores for previously registered information. However, in many cases, people will use separate identifications for constructive commentary and vandalism, which limits the effectiveness of this method. In addition, this technique does not prevent people who know each other well from giving each other good evaluations.

By contrast, the following are examples of systems which primarily use names for posting.

One communication pattern used is to limit communication by only making a person's information available to people known to the person, or people with the same interest as the person. Methods exist for determining who meets the criteria to communicate with the user and read the user's information, and for notification of those who qualify.

In community sites and mailing lists including Nifty (http://www.nifty.com) and Biglobe (http://www.biglobe.ne.jp), a closed community of limited participants is typical. This is effective in situations where the participants invite parties who they know well.

In social networks (SN) typified by Mixi (http://www.mixi.jp) and Orkut(http://www.orkut.com), participation conditions can be imposed based on the relationship between parties such that A's information is made public only to A's friends.

In JP-A-2002-215942 (page 4, FIG. 2), a user database is provided that allows inviting only desirable users to participate in particular discussion topics.

However, in. the communication management systems discussed above, a user does not have sufficient control over his/her level of anonymity with respect to other users, or control over the anonymity of a particular message.

### SUMMARY OF THE INVENTION

In accordance with a first aspect of the present invention there is provided a communication management apparatus including:

a receiving module which receives a message that is posted from a first terminal and includes information about the first terminal;

an acceptance module which accepts a browse request for the received message from a second terminal;

a recording module which records the history of a posting and a reply between the first terminal and the second terminal;

a changing module which processes information about at least the first terminal in the received message in accordance with the history of the posting and the reply; and

a sending module which sends a result processed at the changing module to the second terminal.

In accordance with a second aspect of the present invention there is provided a method for communicating between two computer terminals, the method including:

receiving a message that is posted by a first terminal and includes information about the first terminal;

accepting a browse request for the received message from a second terminal that is difficult from the first terminal;

recording a history of a message posted by the first terminal and a reply to the posted message from the second terminal;

processing information about at least the first terminal in the received message in accordance with the history of the posting and the reply; and sending a processed result to the second terminal.

In accordance with a third aspect of the present invention there is provided a computer-readable medium containing instructions for performing a method for communicating between two computer terminals, the method including:

receiving a message that is posted by a first terminal and includes information about the first terminal;

accepting a browse request for the received message from a second terminal that is difficult from the first terminal;

recording a history of a message posted by the first terminal and a reply to the posted message from the second terminal;

processing information about at least the first terminal in the received message in accordance with the history of the posting and the reply; and sending a processed result to the second terminal.

### BRIEF DESCRIPTION OF THE DRAWINGS

The teachings of the invention can be readily understood by considering the following detailed description in conjunction with the accompanying drawings, in which:

FIG. 1 is a diagram illustrating an exemplary application of a communication management system of an embodiment consistent with the invention;

FIG. 2 is a schematic diagram illustrating a communication management system 100;

FIG. 3 is a diagram illustrating exemplary messages recorded in a message recording part of communication management system 100;

FIG. 4 is a diagram schematically illustrating an operation flow of a message analyzing part of communication management system 100;

FIG. 5 is a diagram schematically illustrating a flow of a changing process of a presentation contents processing part of communication management system 100;

FIG. 6 is a diagram illustrating a flow of a change process step of the changing process;

FIG. 7 is a diagram illustrating a public display policy structure for each message created by the presentation contents processing part, and exemplary contents presented at a message presenting part; and

FIG. 8 is a diagram illustrating an exemplary user relationship presentation screen.

### DESCRIPTION OF EMBODIMENTS

Hereinafter, an embodiment according to the invention will be described with reference to the drawings.

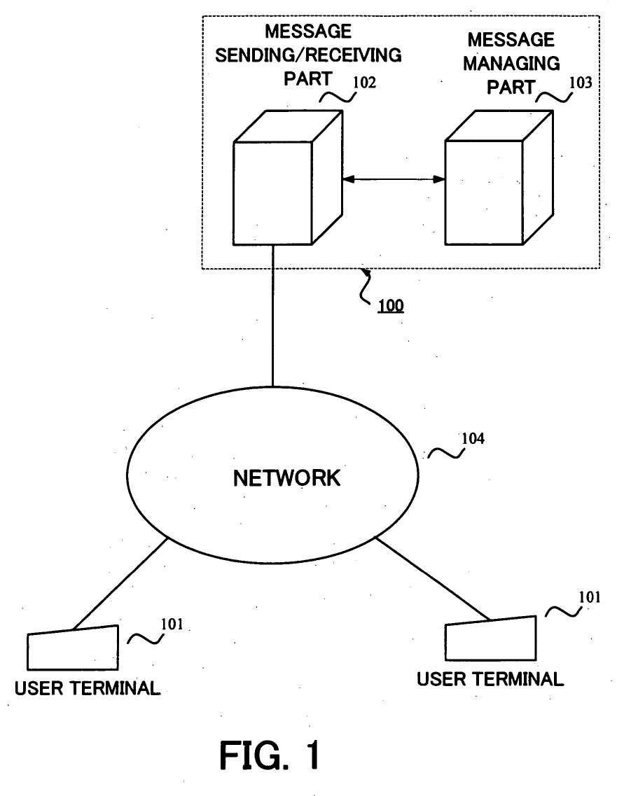

FIG. 1 is a diagram illustrating an exemplary application of a communication management system 100 of an embodiment consistent with the invention. In the embodiment, a user uses a terminal 101 application such as a Web browser, mailer, or instant messaging tool to access the system 100 though networks such as the Internet and/or an intranet. The system 100 includes a message sending/receiving part 102 and a message managing part 103, both exchanging messages with each other. These two units can be placed on the same host computer. However, since the message sending/receiving part 102 can be replaced by a mail server, it may be placed on a plurality of hosts in a distributed manner. A user receives a message sent from the message sending/receiving part 102 to reference information stored in the message managing part 103 in a predetermined format.

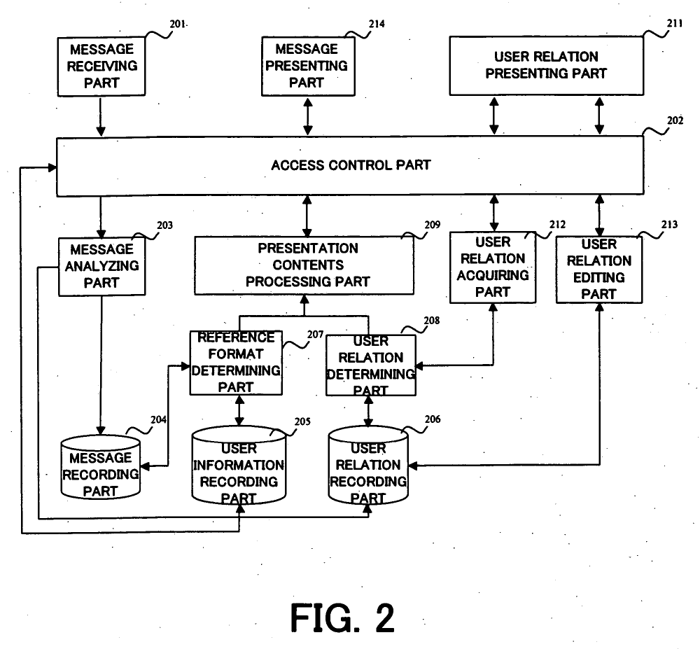

Hereinafter, processing done by the message sending/receiving part 102 and the message managing part 103 according to the embodiment will be described in detail. FIG. 2 is a schematic diagram illustrating a communication management system in which the message sending/receiving part 102 and the message managing part 103 are placed on the same host computer.

A message receiving part 201 receives comments from a user (hereinafter, called amessage), and passes it to a message analyzing part 203 through an access control part 202. There can be various types of messages. In the case of mail applications, the message is information carried by e-mail. Also in Web applications such as bulletin board systems (BBS) and Internet Messenger (IM), the message can be considered to be text similar to e-mail. Furthermore, in the case of voice mail using VoIP, etc., information is accessible as text using a tool which converts spoken words into text.

The access control part 202 uses information stored in a user information recording part 205 to determine whether a user registered in the system is a source contributor of that message, and sends this information along with the message to the message analyzing part 203. Here it is assumed that the system knows the message contributor beforehand. In addition, a form can be used so that when a contributor is not registered, he/she is automatically registered as a new user in the user information recording part 205. Thus, the system can identify a user and the contributor is not anonymous to the system. When a contributor has contributed a message before, the system can handle that contributor as the same user from the previous message.

The message analyzing part 203 determines the user or user group for a given message, and whether the user or group wants to make his/her name public from the body and header of the message, and records the result in a message recording part 204 and a user relation recording part 206. A specific exemplary message analyzing method will be described later.

A message presenting part 214 accepts a browse request from users who wish to view posted messages, and sends an acquisition request for the message to a presentation contents processing part 209 through the access control part 202. When the message is for a Web application, the message presenting part corresponds to a part that accepts a request from a Web browser, and returns the result in a format such as HTML. When the message is for a mail application, messages posted in the message receiving part 201 can be monitored. When a new message is posted, an acquisition request for the message is done for each destination user, and the acquired result is sent as mail to one or more destination users. This input and output style is also known as a mailing list server or a driver.

The presentation contents processing part 209 makes an inquiry to a reference format determining part 207 to determine which public method the contributor wants to use for a person who wants to browse for a particular requested message or message group. At the same time, it makes an inquiry to a user relation recording part 206 about the relationship between the contributor and a person who wants to browse.

The information resulting from these inquiries can be, for example, “wants anonymity: not a strong relationship between the person who wants to browse and the contributor”, “wants to display his/her name: the contributor is not valued highly by the person who wants to browse and his/her acquaintances”, “do not display: no relationship between the person who wants to browse and the contributor”, etc.

The presentation contents processing part 209 uses these items of information to do processing for the presentation contents in a manner expected by both parties. For example, the contributor name is displayed anonymously, the message is made to appear as if the message itself does not exist, or when evaluation is high and the user's name is already known to the requester, his/her name is available even though it is specified to be anonymous. The presentation contents processing part returns the result of this processing to the message presenting part 214.

A user relation presenting part 211 acquires the relationship between a person who wants to browse and the contributor of a specified message from a user relation acquiring part 212, and presents the relationship to a person who wants to browse. What to present as relationship is specified by a user relation determining part 208. For example, whether they have a relationship, the nature of the relationship between them, evaluations of the requester and poster, and whether or not these experiences dictate that the user's name be revealed.

Furthermore, permission on whether to make the user's name available and an evaluation value are given to a user relation editing part 213. The permission and evaluation value are specific to the contributor of the specified message.

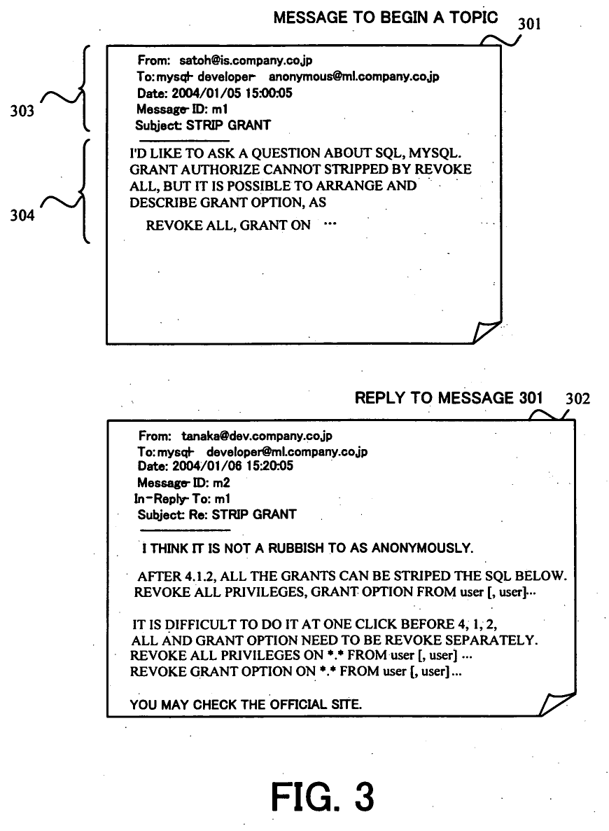

FIG. 3 is an exemplary message that is received by the message receiving part 201 and recorded in the message recording part 204. In this drawing, an example of an e-mail is shown. A message 301 is an exemplary message that begins a topic, and an exemplary message 302 is a reply to message 301. Generally, messages consist of a header 303 and a body 304. The header 303 includes attributes such as contributor (From:), posting destination (To:), concurrent posting destination (Cc:), posting date (Date:), title (Subject:), message identifier (Message-ID:), and the message that is targeted for reply (In-Reply-To:).

Systems besides e-mail for posting messages are described above, including instant messenger (IM) and bulletin board systems (BBS). Systems for posting articles such as WebLog, Blog, and personal diary sites such as Web diaries can also be used consistent with the invention.

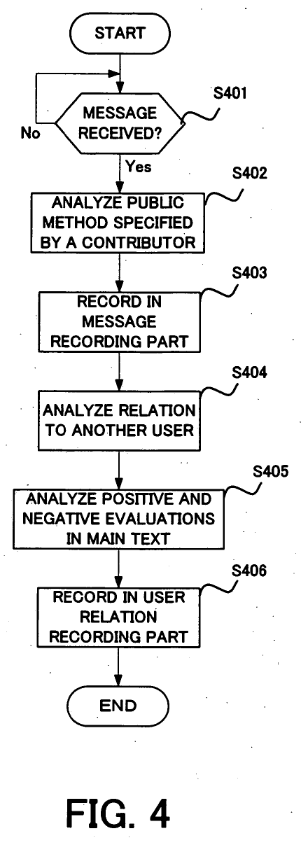

FIG. 4 is a diagram schematically illustrating the flow of operation of the message analyzing part 203. When the message analyzing part 203 receives a message (S401), it analyzes a public method specified by a contributor (S402), and it records analyzed information along with the message itself in the message recording part 204 (S403).

Determination of public methods is generally decided as a system policy before messages are passed, and is not difficult to implement. The following are variations of exemplary policies to specify by whom, to whom, and in which format information is made public.

In the examples below, posting to a mailing list is assumed in which a plurality of users participates.

Fix defaults

Example: All of the mail sent by this user is handled anonymously.

Make his/her name public by default. If the contributor wishes to remain anonymous to some of the recipients, replace the user's name with a character string when displaying the message to those recipients.

Example: Although his/her name is made public in the mail sent by the user, -anonymous is put on the tail of one or more destination addresses to handle as it is anonymous. For example, when anonymity is desired in posting a message to mysql-developer@ml.company.co.jp, the address, mysql-developer-anonymous@ml.company.co.jp can used to specify user anonymity for this recipient.

His/her name is made public in defaults, but it is desired to send to some people as it is anonymous.

Example: At the beginning of the body, addresses of people to whom it is anonymous are listed after prefix, “anonymous”.

This portion is not handled as the body of a message, and is removed before being sent to the message recording part 204.

His/her name is made public in defaults, but the user desires to be invisible to some people for the present.

Example: At the beginning of the body, addresses of people to whom the message is invisible are listed after prefix, “invisible”.

In addition, addresses of people to whom it is visible are listed after writing “visible”. An alias name representing all the participants can be used.

In the message recording part 204, information such as by whom it is posted, in which format and to whom each message is made public is stored along with the message.

Furthermore, it may be specified that a message that is a reply to a certain message inherits the attributes of that message. For example, a message in reply to an anonymous posting defaults to anonymous posting, and if a message is invisible to some people, replies to that message are invisible to those people as well. With this scheme, a discussion style desired by the contributor of the message that starts the discussion can be maintained without error or active management by the other users.

Next, the degree of the relationship of that message to other users is computed (S404) . More specifically, the degree is measured by a predetermined method whether the message has a relationship to a user. By one exemplary method, replies to the message can be used to define the relationship. For example, a method can be considered in which when user B replies to a message posted by user A, for the message of user B, the relation between user A and user B is incremented by 1, whereas when a message posted by user A is a reply posted by user C, the relation between user A and user C is incremented by 0.5.Moreover, relationship based on the expression in the body of the message can also be considered. For example, when a user's name and nickname are described in the body of the message, the relationship can be incremented by 0.3.

There is a degree of relationship between users in the system as a minimum configuration. If it is not desirable that exchanges in genre A have a strong relationship with exchanges in genre B, the system can separately compute a relationship between the genres and for the destination addresses. These relationships can be stored in the message recording part 204.

Next, the body of the message is analyzed for positive and negative evaluations (S405). More specifically, the character strings within the message are analyzed to determine whether the contents are polite and appreciated, or undesirable or even profane. Since there are many existing techniques to extract emotional expression from sentences, these techniques may be used for this analysis. For a minimum configuration, the user manipulates the system so that other users or terminals are classified as “unknown” (that is, ±0 is the relationship of the users).

From the result of the message analysis and the degree of the relationship computed at S404, the strength of relationships between users can be determined, and whether the relationships are positive or negative. Finally, the result of the message analysis is recorded in the user relation recording part 206 (S406). It is acceptable that only a single analyzed result exists in the system as a minimum configuration. However, the system can also be implemented to account for differences between users with respect to various genres, as users may have a positive relationship for some genres and less commonality for other genres (for example, for topics about favorite teams in sports, topics about politics, or topics about religions, users may have very different opinions on each of these topics.). The degree of the relationship between positive and negative evaluations may be separately recorded for each genre and each posting destination address.

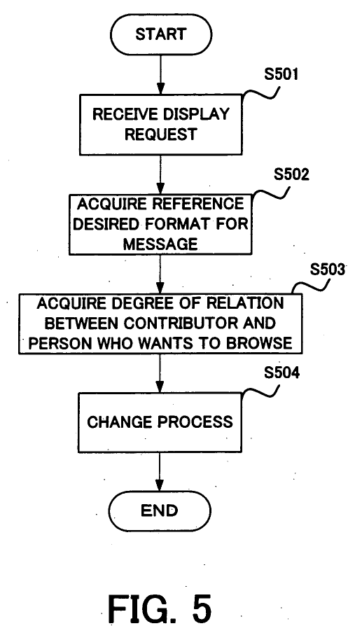

FIG. 5 is a diagram illustrating a schematic flow of a changing process done by the presentation contents processing part 209. The presentation contents processing part 209 is operated by a request for acquiring a message at the message presenting part 214 through the access control part 202 (S501). Information sent from the message presenting part 214 is presentation user information “U_view”, and the message group which the user desires to acquire M_1, M_2 to M_n. The presentation contents processing part passes presentation user information and information about a message group to the reference format determining part 207, and acquires message information and information about how the message is desired to be displayed to the presentation user. More specifically, whether the message should be visible or invisible, or if the user prefers anonymity or that his/her name is made public (S502).

Next, the degree of the relationship between the contributor group and a person who wants to browse is acquired from the user relationship determining part. The degree of the relation of a person who wants to browse to and positive and negative evaluations for each contributor is acquired from the user relation acquiring part. A flag indicating whether permission to make his/her name public is also acquired (S503). Here, one possibility is that the positive and negative evaluations between the contributor and a person who wants to browse are simply positive and negative evaluations between the two people. In addition, another user having a high degree of relationship to a person who wants to browse, the contributor's degree of relationship to that person, and positive and negative evaluations between them are also considered. In the simplest way, it can be determined by the following equation:
EF_a_b=E_a_b +Σ(k,l,n)R_a_k*E_a_k

wherein

n: each user other than “b”.

EF_a_b: final positive and negative evaluations between a contributor “a” and a person “b” who wants to browse.

R_a_k: the degree of the relation between a contributor “a” and a person “k” who wants to browse.

E_a_k: positive and negative evaluations between a contributor “a” and a person “k” who wants to browse.

Σ(k,l,n): The computed results (in this equation,
R_a_k*E_a_k) with respect to each k from k=1 to k=n are summed to derive this quantity.

Alternative definitions may be used, for example taking another user having a high degree of relationship to the contributor, the degree of the relationship of that person to a person who wants to browse, and positive and negative evaluations between them are summed. A person who wants to browse is explicitly provided with a means to prevent negative evaluations with respect to another person who wants to browse, and the values are added and a choice is made.

The change process is completed based on these items of information (S504).

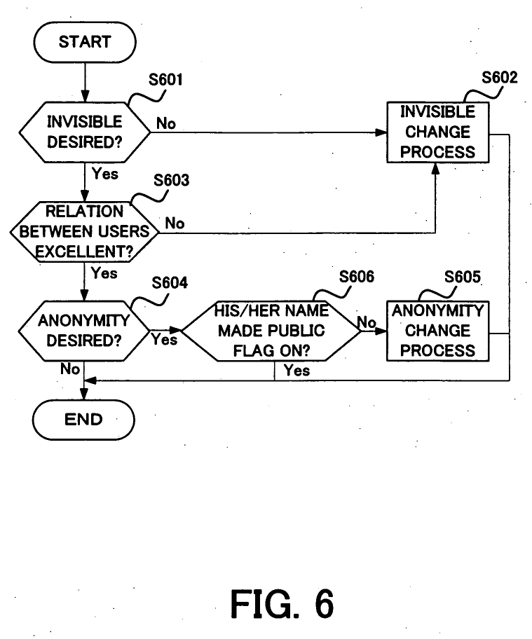

FIG. 6 is a diagram illustrating a schematic flow of the change process done at S504. When the contributor wants to be invisible to a person who wants to browse (S601), a change process is done to make the message invisible (S602). More specifically, the message is deleted from the “browse list” presented to the user who wishes to see messages. Furthermore, a process is done so that serial numbers often seen in a typical mailing list are manipulated so the browser cannot determine that a message is missing. Thus, an illusion can be presented to a person who wants to browse that “no item exists”, not “an item that exists is invisible”. For this process to fill out a serial number, a method of implementing the serial numbers must be chosen. For example, a serial number exclusive for an invisible user can prepared and managed to achieve this result.

Additionally,if positive and negative evaluations of the messages between users is low even though the degree of the relationship between users is high, the invisible change process can be done on for these messages, and a browse user can thus ignore unpleasant user's comments (S603) . It is expected that this method will be selected as an optional function by a user to allow more pleasant browsing and communications.

Next, when a contributor wants to be anonymous to a person who wants to browse (S604), a change process implements the anonymity (S605) . More specifically, the contributor name and posting address are replaced by a character string such as “no name”, “anonymous”, “wants anonymity”. Furthermore, a character string for identifying a person often included in header information such as a message identifier (Message-ID) is all replaced by a dummy character string. At this time, if the contributor permits his/her name to be made public to a person who wants to browse, the anonymity change process can be skipped (S606).

A single flag exists in the system to indicate whether the user wishes his/her name to be made public to other users, as a minimum configuration for a given pair of users. Alternately, if a user wishes to remain anonymous with respect to some genres of conversation but to reveal his name with messages in other genres, an anonymous public flag may be maintained for each genre and each posting destination address. Other options can be considered such as revealing his/her name only for a particular discussion, which may be very effective in some scenarios. As described above, the anonymous public flag is held in the user relation recording part 206.

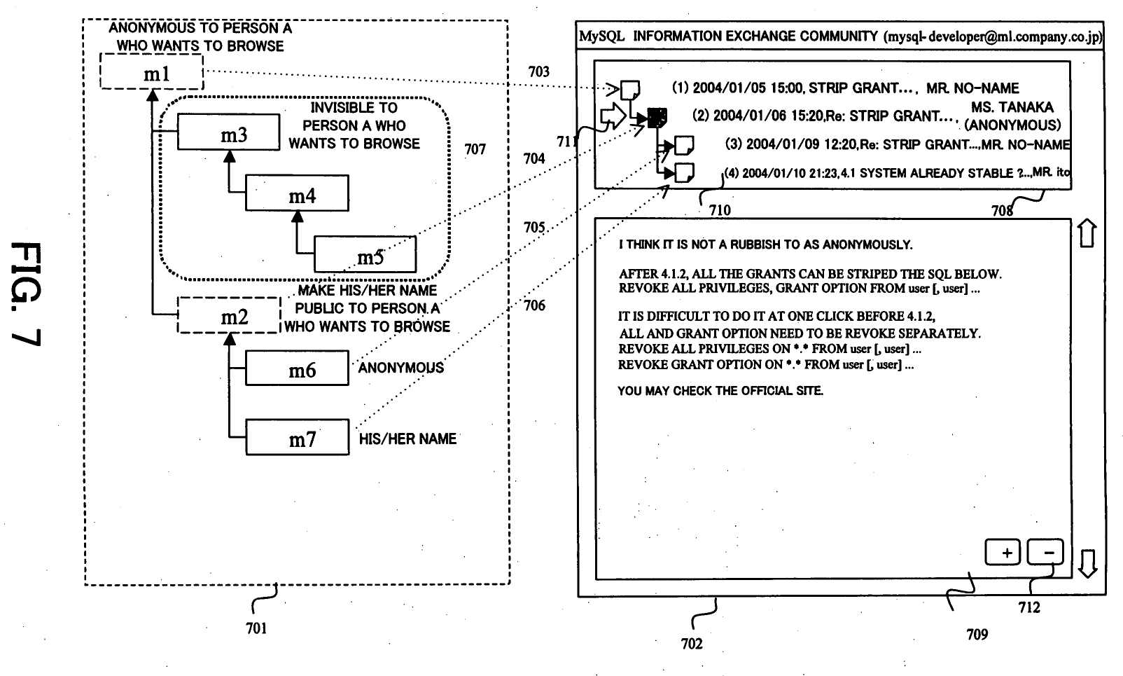

FIG. 7 is a diagram illustrating an exemplary public display policy structure (701) for each message processed by the presentation contents processing part 209. Also, exemplary contents (702) shown on the message presenting part 214 are illustrated. It is assumed that a browsing user is browsing through a graphical interface such as a Web browser. This example is a two-pane viewer having a list view (708) in which a browse request message is arranged above and a reply relationship is arranged below on a tree, and a contents viewer (709) on which a message is displayed. A horizontal arrow 711 in the list view indicates a message displayed on the contents viewer. A +button and −button (712) on the lower part of the contents viewer are used by a browse user to explicitly evaluate the user who posted this message. When the + or − is selected, the evaluation is notified to the user relation editing part 213 as a correct value of positive and negative evaluations for the contributor of this message.

Messages m1 and m6 are anonymously displayed, messages m3, m4, and m5 are invisible because of low positive and negative evaluations to a user (707), message m2 allows making the contributor's name public to the person who wants to browse, and message m7 allows making the user's name public to all people who want to browse. In this case, on the list viewer 708 of the message presentation screen 702, a contributor is shown as “Mr./Ms. No-name” in an anonymous message (703, 705), and is shown as “Mr./Ms. XXX (anonymous)” in a message where his/her name is only made public to the person who wants to browse (704). In addition, a message that specifies invisibility is not displayed (707). In this embodiment, the serial number is reassigned for the person who wants to browse so the user cannot determine that there are invisible messages(710).

For more thorough schemes, a filter for anonymity is applied to the text in the body as well. Varying serial numbers depending on browse users can possibly cause communications to be difficult between terminals. A process that replaces serial number by a browse user may be required as a support function in this circumstance. Detailed descriptions of these methods are omitted because they are readily available. Even in the simplest scheme, processing is done in such a way that a user's name is invisible to most of the users participating in the discussions. Generally, since an unpopular person is disliked by most users, it can be said that the method is sufficient for maintaining a high quality of communication.

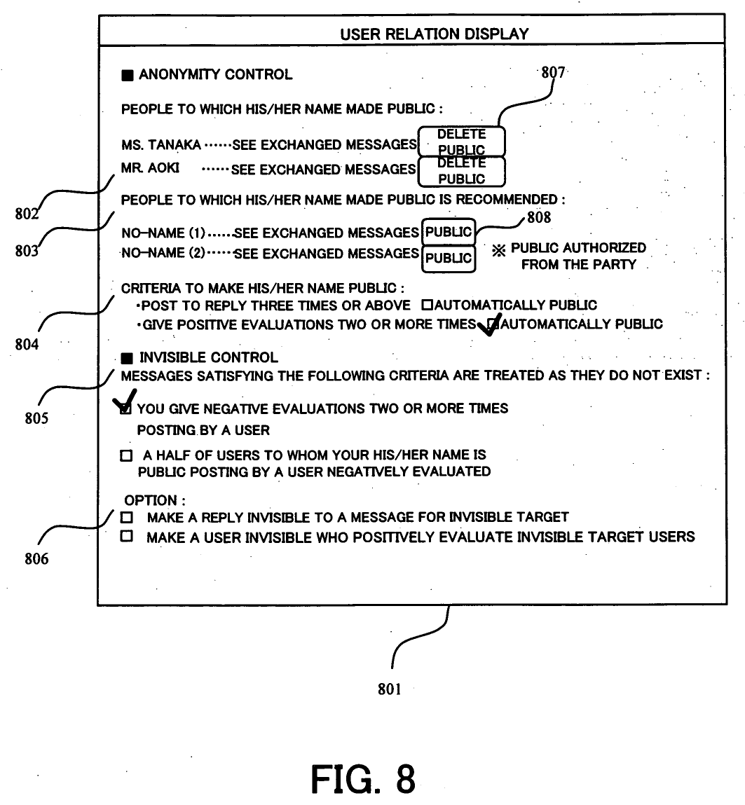

FIG. 8 is a diagram illustrating an exemplary user relation presentation screen 801. The screen 801 sends an instruction to the user relation editing part 213. The instruction sent from the screen is reflected in the contents of the user relation recording part 206 through the user relation editing part 213.

On the screen 801, users whose names are made public, and anonymous users (802) whose names are not made public but who have good exchanges so far are listed. For users whose name is made public, a public delete button 807 is selected to instruct the user relation editing part 213 to toggle the flag so the user name is no longer available. Moreover, for anonymous users who have a good relationship so far, a public button 808 is selected to toggle the flag so the user name is available. Settings for user recommendation 804 determine criteria for whether a “good relationship” exists between the users.

A good relationship is originally determined at the user relation determining part 208, but that value can be corrected here. In this exemplary screen, “good relationship” can be specified by the number of posts to which the user replies, and the number of times the +button 712 in the message presentation screen 702 is pressed. When it is burdensome to take the trouble to send a public instruction on the user relation display screen, “automatically made public” is selected to automatically make the user name public.

In this example, making his/her name public is allowed only when both users agree to make their names available to one another. When one user makes his name available to the other, the other user receives information that “the receiver has made his/her name public.”

By using an invisibility control 805, a user can set a condition to ignore posting by an unpleasant user. In this exemplary screen, one method of setting a user as an unpleasant user is based on the number of times the −button 712 in the message presentation screen is pressed. Another method is that a user is negatively evaluated by half of the users to whom his/her name is made public. This method allows a user to rely on other's judgment with respect to a particular user. Therefore, a reliable group can collectively remove an undesired posting. A user can set criteria so that particular users' judgments are considered, anywhere from just one other user to the judgment of all of the system's users. Using fewer other users' will likely yield less reliable judgment, or may result in invisible messages that the user would actually like to see. By contrast, when the number of users' whose judgment is considered is increased, less effort needs to be exerted to accomplish collective removal of messages.

An additional technique can be used in the selection (806). In the present example, if a user has targeted a message to be invisible to a particular user, the user's name is invisible in replies to that message as well. Further, the contributor's name is invisible not only to users the contributor has specified, but to users that have given positive evaluations to the specified users. In other words, the system targets, for the purpose of ignoring them, not only users who have negative relationships with the contributor, but users who have positive relationships with the targeted users.

As described above, according to the embodiment, a user can anonymously communicate with a given user at a given time, and his/her names can be made public under appropriate conditions as the relationship grows. Furthermore, vandals who misuse their anonymity can be removed by a scheme that is difficult for the abusers to discover. The system maintains the low entry barriers of anonymous communications, and can be fully used to promote the formation of communities that are difficult to generate without such anonymity. Consequently, difficulties caused, for example, by the introverted nature of Japanese characteristics can be overcome.

Numerous modifications of the present invention are possible in light of the above teachings. It is therefore to be understood that, within the scope of the appended claims, the present invention can be practiced in a manner other than as specifically described herein.

What is claimed is:

1. A communication management apparatus comprising:
a receiving module which receives a message that is posted from a first terminal and includes information about the first terminal;
an acceptance module which accepts a browse request for the received message from a second terminal that is different from the first terminal;
a recording module which records history of a posting and a reply between the first terminal and the second terminal;
a changing module which processes information about at least the first terminal in the received message in accordance with the history of the posting and the reply; and
a sending module which sends a result processed at the changing module to the second terminal.

2. The communication management apparatus according to claim 1, further comprising a selecting module which selects a public method to the second terminal based on the history of the posting and the reply when the first terminal posts the message.

3. The communication management apparatus according to claim 1, further comprising an estimating module which estimates whether the first terminal and the second terminal have a close relation to each other in accordance with the history of the posting and the reply,
wherein the changing module processes the received communication information in accordance with a close relation between the first terminal and the second terminal estimated at the estimating module.

4. The communication management apparatus according to claim 3, wherein the history of the posting and the reply is based on a reply relation of messages between the first terminal and the second terminal.

5. The communication management apparatus according to claim 3, wherein the history of the posting and the reply is based on expression of messages between the first terminal and the second terminal.

6. The communication management apparatus according to claim 3, wherein:
in a case where the estimating module estimates that a close relation between the first terminal and the second terminal is a fixed value or below, and the changing module sets information about the first terminal anonymous to the second terminal,
when the estimating module again estimates that a close relation between the first terminal and the second terminal is a fixed value or above, the changing module releases anonymity of information about the first terminal with respect to the second terminal.

7. The communication management apparatus according to claim 3, wherein when the estimating module estimates that the first terminal has a close relation of a fixed value or below to the second terminal, the changing module processes a posting from the first terminal so as not to be presented to the second terminal.

8. The communication management apparatus according to claim 3, wherein in a case where the estimating module estimates that a close relation between the first terminal and the second terminal is a fixed value or below, and estimates that a close relation between the second terminal and a third terminal that makes a browse request to a posting in the first terminal is a fixed value or above,
the estimating module estimates that a close relation between the first terminal and the third terminal is a fixed value or below.

9. A method for communicating between two computer terminals, the method comprising:
receiving a message that is posted by a first terminal and includes information about the first terminal;
accepting a browse request for the received message from a second terminal that is difficult from the first terminal;
recording a history of a message posted by the first terminal and a reply to the posted message from the second terminal;
processing information about at least the first terminal in the received message in accordance with the history of the posting and the reply; and sending a processed result to the second terminal.

10. A computer-readable medium containing instructions for performing a method for communicating between two computer terminals, the method comprising:
receiving a message that is posted by a first terminal and includes information about the first terminal;
accepting a browse request for the received message from a second terminal that is difficult from the first terminal;
recording a history of a message posted by the first terminal and a reply to the posted message from the second terminal;
processing information about at least the first terminal in the received message in accordance with the history of the posting and the reply; and sending a processed result to the second terminal.
